(19) United States
(12) Patent Application Publication
(10) Pub. No.: US 2001/0029464 A1
(43) Pub. Date: Oct. 11, 2001

(54) Method for conducting on-line transactions

(76) Inventor: F. Christian Schweitzwer, Westfield, MA (US)

Correspondence Address: FOLEY, HOAG & ELIOT, LLP, PATENT GROUP, ONE POST OFFICE SQUARE, BOSTON, MA, 02109, US

(21) Appl. No.: 09/781,026

(22) Filed: Feb. 9, 2001

Related U.S. Application Data
(60) Provisional application No. 60/182,363, filed on Feb. 14, 2000.

(51) Int. Cl. G06F 17/60

(52) U.S. Cl. 705/14; 705/26

(57) ABSTRACT

There is disclosed herein a system of allowing an on-line merchant to incentivize secondary sales at a selected brick-and-mortar store comprising: offering a rebate coupon to a consumer over a computer network; basing the value of the rebate coupon on the value of an on-line transaction; offering the consumer a choice of brick-and-mortar stores for which he may receive the rebate coupon; transmitting the rebate coupon from a rebate coupon provider to the consumer to provide the consumer with an incentive for visiting a brick-and-mortar retail store; and offering upon issue of the rebate coupon by the rebate coupon provider (1) a sales commission to the sales representative group servicing a retail store selected by the consumer; and/or (2) a discount to the retail store on future purchases of products from the on-line retailer.

### FIELD OF THE INVENTION

This application relates to the field of computer technology and more particularly to the field of electronic commerce transactions.

### BACKGROUND OF THE INVENTION

The ability to conduct transactions conducted over the Internet, referred to as electronic commerce or e-commerce, has created a low-cost point of entry into the market for manufacturers who traditionally do not retail their goods. On balance, digital store fronts and physical, “brick-and-mortar” stores offer different advantages; on-line shopping is relatively more convenient, whereas brick-and-mortar stores allow the consumer to see and feel the actual good before purchase.

However, digital store fronts compete with brick-and-mortar retailers for consumers. When manufacturers begin to sell their products on-line, this competition can be potentially disruptive to the market. Brick-and-mortar retailers may retaliate against manufacturers who sell on-line by refusing to carry their goods. On the other hand, on-line retailers may drive brick-and-mortar retailers out of business, reducing the number of potential outlets for the sale of goods. Thus, a need exists for a novel method of harmonizing this relationship and allowing both manufacturers and brick-and-mortar retailers to benefit from e-commerce.

### DETAILED DESCRIPTION OF THE ILLUSTRATED EMBODIMENT

This method and system of performing an on-line transaction facilitates the development of a market where both on-line sellers and brick-and-mortar sellers may benefit from on-line sales.

When completing a purchase on a third-party electronic retailer's web site, the consumer may be offered the option of receiving a rebate coupon. If the consumer chooses to receive the rebate coupon, the third-party web server will link the consumer's web browser to the web site of the coupon provider. In addition, the third-party web site may transmit data about the transaction to the coupon provider's server. Such data may include, for example, the amount of the transaction, the identity of the on-line seller, and any other such information relevant to the transaction.

The coupon provider's server may then offer to the consumer a choice of retail outlets for which the consumer may receive a rebate coupon. The list of choices may be, for example, a list of a manufacturer's customers. It may also be, for example, a list of stores in the consumer's area code or zip code.

When the consumer chooses a retail outlet, the coupon provider's server generates a rebate coupon, which may comprise, for example, a printable HTML page with a unique serial number, the name of the retail outlet selected, and the value of the coupon. The value of the coupon may be based on the value of the consumer's purchase at the third-party web site. For example, it may be a percentage of the sale conducted between the consumer and the on-line seller.

In addition, the coupon provider's server may transmit data about the rebate coupon, such as the transaction amount, the unique serial number, and the retail outlet selections, to the on-line seller by electronic mail or other such suitable means. For providing this service, the coupon provider may charge a nominal fee, for example, 1% of the transaction.

The consumer may then print a paper copy of the rebate coupon for later use on purchases made at the particular brick-and-mortar store selected by the consumer. After the consumer later makes a purchase at the brick-and-mortar store, he may mail the rebate coupon to the on-line retailer, together with a UPC bar code or similar such evidence of his purchase. The on-line retailer may then rebate the value of the coupon to the consumer.

In addition, the brick-and-mortar retailer chosen by the consumer may directly benefit in several ways. First, the brick-and-mortar retailer receives the consumer's business when he makes a later purchase at the store to take advantage of his rebate coupon. Second, the on-line retailer, based on information provided by the coupon provider, may pay a commission to the sales representative group at the brick-and-mortar store. This commission may be calculated as a percentage of the value of the on-line sale between the consumer and the on-line retailer. Third, the on-line retailer, based on information provided by the coupon provider, may provide a discount to the brick-and-mortar store on future purchases of goods; this is particularly applicable in the case where, for example, the on-line retailer is a manufacturer of goods carried by the brick-and-mortar store. Thus, the method and system described herein encourages the development of a market where both on-line retailers, commissioned sales people, and brick-and-mortar retailers benefit from e-commerce.

One example of this method and system may be the provision of a coupon for a purchase of stationery. In one contemplated embodiment, the third-party on-line retailer is a manufacturer of fine stationery and desk accessories, such as Renner Davis. The consumer makes a purchase from a Renner Davis web site. When completing the transaction, the consumer is offered an option to receive a rebate coupon. If the consumer chooses to receive the coupon, the Renner Davis server then links the consumer's web browser to the coupon provider's web site. Additionally, the Renner Davis web server may transmit data about the transaction to the coupon provider's server.

The coupon provider's server then provides the consumer with a choice of retail outlets for which the consumer may receive a rebate coupon. This list may be, for example, a list of Renner Davis customers in the consumer's area code or zip code. When the consumer selects a brick-and-mortar retail outlet, for example, Staples, the coupon provider's server may generate a rebate coupon in the form of, for example, a printable HTML page, containing information about the rebate coupon granted, for example, a unique serial number, the value of the rebate, and the name of the retail outlet selected. The coupon provider server may also transmit back to the Renner Davis server information such as the coupon serial number, then name of the retail outlet selected, and the value of the rebate coupon. The consumer may then print a copy of the rebate coupon for later use.

To continue this example, after the consumer has made a purchase of a Renner Davis product at Staples, he may then mail the rebate coupon and evidence of his purchase, for example, a UPC code, to Renner Davis. Renner Davis may then (1) rebate the value of the coupon to the consumer, (2) pay a commission to the sales representative group at the Staples selected by the consumer, calculated, for example, as a percentage of the on-line sale, (3) offer a discount to that Staples on future purchases of Renner Davis products, or any combination thereof.

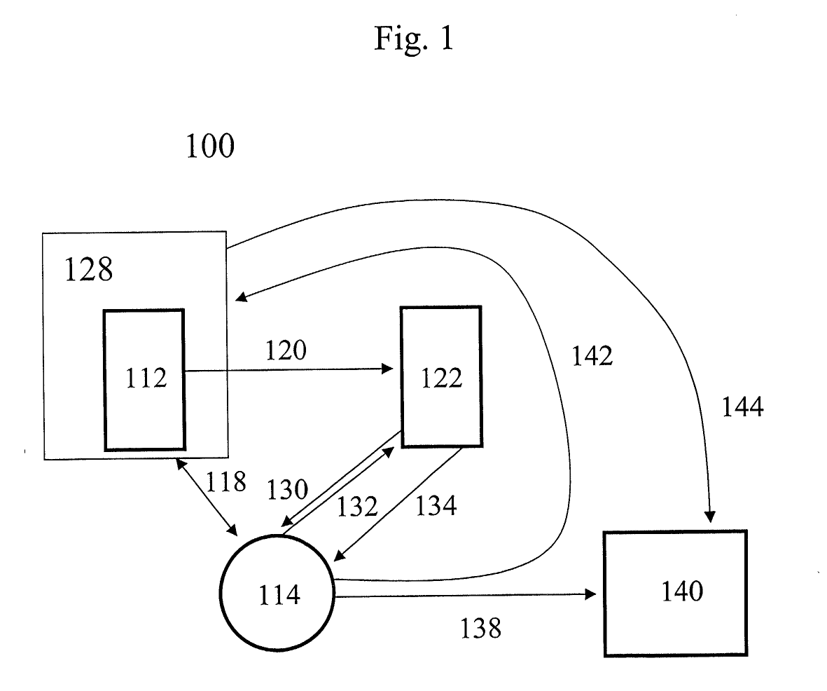

FIG. 1 is an example of one embodiment of a method 100 according to the invention for performing an on-line transaction which facilitates the development of a shared market. Specifically, FIG. 1 illustrates a method 100 where a consumer 114 performs a transaction 118 with an on-line retailer web server 112. If the consumer 114 chooses to receive a rebate coupon, the on-line retailer web server 112 links the consumer 114 with the coupon provider's web server 122. Additionally, the on-line retailer web server 112 sends data about the transaction 120 to the coupon provider web site 122. The coupon provider web server 122 presents the consumer 114 with a list of options of stores 130 for which he would like to receive a rebate coupon. For example, the coupon provider web server may present the consumer with an HTML page that acts as a user interface. The consumer 114 submits his choice 132 to the coupon provider web server 122. The coupon provider web server 122 provides the consumer 114 with a printable rebate coupon 134 in the form of, for example, an HTML page, containing information about the rebate coupon such as, for example, a unique serial number, the value of the rebate, and the name of the retail outlet selected. The consumer may then print a copy of the rebate coupon, and make a purchase 138 at the selected retail outlet store 140. To receive the rebate, the consumer 114 may mail the rebate coupon and proof of his purchase 142, such as, for example, a UPC code, to the on-line retailer 128. After receipt of the rebate coupon and the proof of purchase, the on-line retailer 128 may make various offers 144 to the brick-and-mortar store 140 such as, for example, a commission to the sales representative group based on the value of the on-line transaction 118, or, in the case that the on-line retailer is also a manufacturer, a discount on future purchases of goods from the coupon provider.

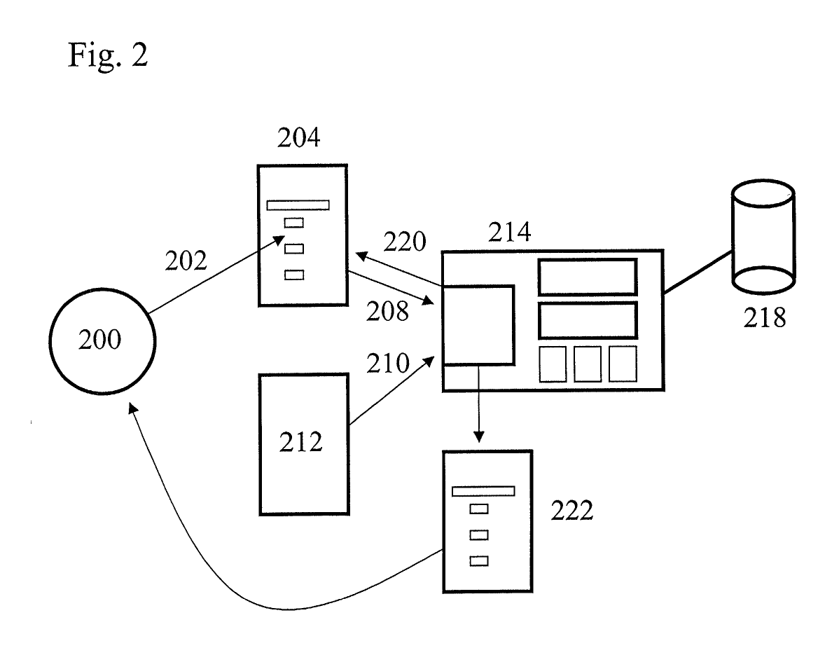

FIG. 2 is an example of one embodiment of a server 214 for performing the generation of a rebate coupon. Although server 214 is depicted as functional block elements, it will be apparent to one of ordinary skill in the art that elements of this diagram can be realized as computer programs or portions of computer programs that are capable of running on the server as a system according to the invention. The server 214, which may include Apache web server or any suitable web server, receives information about a third-party transaction 210 from a third-party server 212. Server 214 may also employ a number of scripts, which may be CGI scripts or any suitable scripts, which parse the information provided from the third-party server 212. The server 214 also comprises a database 218 wherein it stores and retrieves various transaction-related data. The server 214 provides a consumer 200 with a list of retail outlet choices on an HTML page 204. The consumer 200 enters a choice onto the HTML page 204 which is transmitted 208 to the server 214. The information from the consumer 208 is parsed by the server 214. The server 214 generates a printable HTML page which serves as the consumer's rebate coupon 222 which is transmitted to the consumer 200.

While the invention has been disclosed in connection with the preferred embodiments shown and described in detail, various modifications and improvements thereon will become readily apparent to those skilled in the art. Accordingly, the spirit and scope of the present invention is to be limited only by the following claims.

1. A method of allowing an on-line merchant to incentivize secondary sales at a selected brick-and-mortar store comprising:
offering a rebate coupon to a consumer over a computer network;
basing the value of the rebate coupon on the value of an on-line transaction;
offering the consumer a choice of brick-and-mortar stores for which he may receive the rebate coupon;
transmitting the rebate coupon from a rebate coupon provider to the consumer to provide the consumer with an incentive for visiting a brick-and-mortar retail store; and
offering upon issue of the rebate coupon by the rebate coupon provider
(1) a sales commission to the sales representative group servicing a retail store selected by the consumer; and/or
(2) a discount to the retail store on future purchases of products from the on-line retailer.

2. A method according to claim 1 of allowing an on-line merchant to incentivize secondary sales at a selected brick-and-mortar store comprising:
basing the value of the rebate coupon on the value of an on-line transaction, wherein the value is transmitted from a first server to a second server.

3. A method according to claim 1 of allowing an on-line merchant to incentivize secondary sales at a selected brick-and-mortar store comprising:
offering the consumer a choice of brick-and-mortar stores for which he may receive the rebate coupon, wherein the selection of stores offered to the consumer is based on the consumer's area code, zip code, or individual preference.

4. A method according to claim 1 of allowing an on-line merchant to incentivize secondary sales at a selected brick-and-mortar store comprising:
transmitting the rebate coupon from a rebate coupon provider to the consumer to provide the consumer with an incentive for visiting a brick-and-mortar retail store, wherein the transmission occurs over a computer network.

5. A method according to claim 1 of allowing an on-line merchant to incentivize secondary sales at a selected brick-and-mortar store comprising:
offering to a brick-and-mortar retail store, based on the value of an on-line transaction
(1) a sales commission to a retail store selected by the consumer; and/or
(2) a discount to a retail store on future purchases of products from the rebate coupon provider.
